(19) United States
(12) Patent Application Publication
(10) Pub. No.: US 2026/0366940 A1
(43) Pub. Date: Nov. 19, 2026

(54) Pressure-sensor element

(71) Applicant: Knorr-Bremse Systeme für Nutzfahrzeuge GmbH, München (DE)

(72) Inventor: Stefan Prams, Unterschleissheim (DE)

(73) Assignee: Knorr-Bremse Systeme für Nutzfahrzeuge GmbH, München (DE)

(21) Appl. No.: 19/133,802

(22) PCT Filed: Oct. 31, 2023
(86) PCT No.: PCT/EP2023/080308

§ 371 Date: May 29, 2025

(30) Foreign Application Priority Data
Nov. 30, 2022 (DE) 10 2022 131 802.8

(51) Int. Cl. G01L 19/06; G01L 19/00

(52) U.S. Cl. CPC G01L 19/0654; G01L 19/0038

(57) ABSTRACT

A pressure-sensor element comprising a pressure sensor for sensing a pressure in a gas; and a protective element which forms a channel with a wide region and a narrow region and comprises a retaining projection, wherein the narrow region adjoins the pressure sensor, wherein the narrow region has a smaller cross-section than the wide region, wherein the protective element is arranged on the pressure sensor in such a way that the gas is passed through both the wide region and the narrow region to the pressure sensor, and wherein the retaining projection, which is arranged at a passage between the wide region and the narrow region, protrudes into the wide region in order to prevent liquid from an edge portion of the wide region from entering the narrow region.

### BACKGROUND AND SUMMARY

The present approach relates to a pressure-sensor element according to the main claim.

Systems that use compressed air to enable their function can be used for commercial vehicles. These systems can measure the pressure in the system at various points, for example to determine the status of the system and enable functions. Typically, a pressure channel is connected to a sensor so that the pressure in the resulting volume can be sensed by the sensitive region of the sensor. The dimensions are often narrowed (pressure channel, rather larger, narrowing towards the sensitive region of the sensor, e.g. membrane). One of the advantages of this is that only a small part of the electronics comes into contact with the pressure, so that although the pressure can be measured, the resulting force load (force =pressure times area) on components, connection technology, etc. is lower.

As the pressure of a gaseous medium (air) is to be measured in the systems, it is a known problem if liquids or solids are present in the measurement region and come into the vicinity of the sensitive region or the pressure sensor. Regardless of the origin of the liquid (e.g., loss of cold from the compressed air, fault in the air drying and filter unit, etc.), this can cause problems for the pressure measurement.

Problems can already occur in the liquid state or due to icing of the liquid in the sensor, for example at or in one of the constrictions. This can interfere with the measuring process or permanently damage the measuring electronics, which has consequences for the function and safety of the system (failure, bottle readings, etc.). The connection with the typical environmental conditions (e.g., high temperature ranges including sub-zero temperatures) that favor the problem should also be pointed out here.

Against this background, the object of the present approach is to create an improved pressure-sensor element.

### DISCLOSURE OF THE INVENTION

The approach presented here creates a pressure-sensor element with the following features: a pressure sensor for sensing a pressure in a gas; and a protective element which forms a channel with a wide region and a narrow region, wherein the narrow region adjoins the pressure sensor and has a smaller cross-section than the wide region, wherein the protective element is arranged on the pressure sensor in such a way that the gas is passed through the wide region and the narrow region to the pressure sensor, and wherein the protective element further comprises a retaining projection which is arranged at a transition between the wide region and the narrow region and protrudes into the wide region in order to prevent liquid from an edge portion of the wide region from entering the narrow region.

In the present case, a pressure sensor can be understood as a sensor that can sense pressure in a gas. A protective element can be understood as a body that has, for example, a channel through which the gas can pass and be guided to the pressure sensor. The protective element comprises a channel with a wide region and a narrow region, wherein the wide region has a larger cross-section than the narrow region. In this respect, the protective element acts as a guide element for the pressure, first through the wide region and then through the narrow region to the pressure sensor. A retaining projection can be understood to be, for example, a lug, elevation or a ridge-shaped element which is attached to the narrow region of the protective element or the base (region or portion) of the wide region and extends into the wide region of the protective element so that it forms a barrier to prevent objects or liquids from entering the narrow region when they are located at an edge region or base of the wide region of the protective element.

The approach presented here offers the advantage of realizing an improved protective function through the use of this retaining projection, as, for example, the aforementioned liquids can be prevented from penetrating from the wide region into the narrow region. This makes the pressure-sensor element more robust against interference and/or damage.

A particularly favorable embodiment of the approach proposed here is one in which one end of the retaining projection is at a greater distance from the pressure sensor than a base region of the wide region. A base region of the wide region can be understood as a portion that delimits the wide region at a transition to the narrow region. Such an embodiment of the approach proposed here offers the advantage that the retaining projection forms a threshold or step which subsequently prevents the liquid or an object from penetrating from an edge of the wide region into the narrow region.

Another conceivable embodiment of the approach proposed here is one in which the base region of the retaining projection has a falling or sloping course and/or wherein the base region adjacent to the retaining projection is at a greater distance from the pressure sensor than an edge of the base region opposite the retaining projection. Such an embodiment offers the advantage of being able to keep liquid away from the retaining projection as far as possible due to the inclined or sloping portion of the base region, which results in less maintenance and thus a reduced susceptibility to faults of such a pressure-sensor element.

In order to be able to prevent liquid from entering the narrow region as far as possible, the base region can also have a substantially parallel alignment in relation to the alignment of the pressure sensor and/or in which the retaining projection is shaped as an elevation or ridge.

According to a further embodiment, the retaining projection can be arranged circumferentially around an opening or the passage to the narrow region. Such an embodiment of the approach proposed here offers the advantage of a particularly reliable protective effect of the retaining projection, as this now no longer leaves any gaps through which liquids or objects could penetrate from an edge region of the wide region into the narrow region, for example.

For very efficient guidance of liquid deposited, for example, on a wall of the wide region, inner walls of the wide region can be conical or form a tapering channel and/or inner walls of the narrow region can be arranged substantially parallel to one another, in particular wherein the wall of the narrow region is flush with a wall of the retaining projection.

Furthermore, an embodiment of the approach proposed here is advantageous, in which an inner wall of the narrow region and/or an inner wall of the wide region (120) has a step, in particular wherein the step has a gradient sloping downwards from the passage to the edge region of the inner wall of the wide region or the narrow region. Such an embodiment offers the advantage that a protective effect can again be achieved by the step formed by the antenna wall of the steel region, even if liquids have entered the protective element from the wide region into the narrow region.

According to a further embodiment of the approach proposed here, the protective element can also be at least partially cylindrical and/or at least partially comprise a plastics material and/or a rubber material. Such an embodiment offers the advantage of particularly simple manufacture, for example by means of known casting processes or injection molding processes.

According to one embodiment, the pressure sensor is particularly well protected if it is embedded in a chamber portion of the protective element. Such an embodiment offers the advantage of designing the protective element in such a way that the pressure sensor is also surrounded, so that environmental influences can have very little effect on the pressure sensor and thus the pressure-sensor element manufactured in this way can be designed to be very robust and stable.

According to a further embodiment, the narrow region can also be arranged asymmetrically to the wide region. This can enable very good guidance of deposited moisture or good protection against the penetration of foreign bodies into the narrow region.

A particularly favorable embodiment of the approach presented here is one in which a hydrophilic surface structure is provided on the inside of a wall of the wide region, in particular at an end facing the narrow region. Such an embodiment offers the advantage of being able to retain liquids in the region of the wide region by means of such a surface structure, so that penetration of these liquids into the narrow region can be effectively prevented.

Alternatively or additionally, according to another embodiment, a hydrophobic surface structure can be provided on the inside of a wall of the narrow region and/or in which the protective element consists of a hydrophobic material or at least partially comprises a hydrophobic material. The basic idea of the present invention can also be realized quickly and efficiently by such an embodiment, since the hydrophobic surface structure in the inner region of the narrow region can now also prevent or avoid as far as possible the penetration of a liquid into the narrow region.

### SUMMARY OF THE DRAWINGS

Various exemplary embodiments of the approach presented here are described in more detail below with reference to the various figures, in which:

FIG. 1 shows a sectional view through a first exemplary embodiment of the pressure-sensor element presented here;

FIG. 2 shows a sectional view through a second exemplary embodiment of the pressure-sensor element presented here;

FIG. 3 shows a sectional view through a third exemplary embodiment of the pressure-sensor element presented here;

FIG. 4 shows a sectional view through a fourth exemplary embodiment of the pressure-sensor element presented here;

FIG. 5 shows a sectional view through a fifth exemplary embodiment of the pressure-sensor element presented here;

FIG. 6 shows a plan view of the fifth exemplary embodiment of the pressure-sensor element presented here;

FIG. 7 shows a sectional view through a sixth exemplary embodiment of the pressure-sensor element presented here;

FIG. 8 shows a sectional view of a seventh exemplary embodiment of the pressure-sensor element presented here; and

FIG. 9 shows a sectional view through an eighth exemplary embodiment of the pressure-sensor element presented here.

The same or similar reference signs are used in the following description for identical or similar elements, wherein a repeated description is dispensed with for reasons of simplification.

### DETAILED DESCRIPTION OF THE DRAWINGS

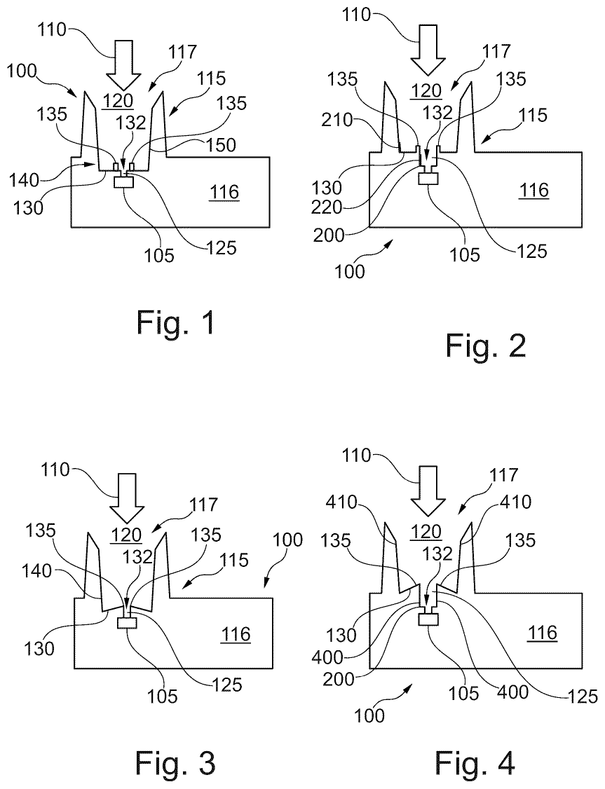

FIG. 1 shows a sectional view through an exemplary embodiment of the pressure-sensor element 100 presented here. The pressure-sensor element 100 comprises a pressure sensor 105 which is designed, for example, to sense a pressure of a gas 110. In order to now circumvent the aforementioned problem that penetration of liquid or objects onto or into the immediate region around the pressure sensor impairs the functionality of the pressure-sensor element 100, a protective element 115 is used in accordance with the approach presented here, in which the pressure sensor 105 is embedded, for example in a chamber portion 116, and which comprises a channel 117 which is divided into a wide region 120 and a narrow region 125, wherein the wide region 120 has a larger cross-section than the narrow region 125. At an end of the wide region 120 facing the pressure sensor 105, a base portion or base region 130 is provided, at which a retaining projection 135 or a plurality of corresponding retaining projections 135 are provided in the region of a passage 132 from the wide region 120 to the narrow region 120, which, for example, also form a circumferential retaining projection around this passage from the narrow region 125 into the wide region 120.

If, for example, a liquid is now separated from the gas 110 by condensation on a wall of the protective element in the wide region 120 or an object enters the wide region 120 of the protective element, the provision of the retaining projection 135 can very simply prevent a liquid located in the edge region or edge portion 140 of the base region 130 or an object located there from reaching an opening in the narrow region 125 through a flow of the gas 110 and thus impairing the functionality of the pressure sensor 105. By the arrangement of the retaining projection 135 or the retaining projections 135, such a protective function for the pressure sensor 105 can now be realized by technically very simple means.

Furthermore, it is also favorable if the protective element 115 is designed in such a way that it at least partially, or more favorably completely, surrounds the pressure sensor 105, so that, for example, the pressure sensor 105 is embedded in the protective element 115 in a chamber portion 117. In this way, the pressure sensor 105 can be very securely and reliably protected against environmental influences as well as against impacts or damage. The protective element 115 can also be manufactured particularly cost-effectively if it is formed from a plastics material or rubber, in particular if it is injection molded or cast. It is also advantageous if a hydrophilic surface structure 150 is arranged on an inner wall of the protective element 115 in the wide region 120. In this way, for example, a liquid that runs down this inner wall can be adsorbed or held on this hydrophilic surface structure, so that the liquid can be prevented from running into the narrow region 125. The hydrophilic surface structure can be created, for example, by etching trenches or grooves into the wall of the protective element 115 in the wide region 120 or also by applying a special hydrophilic layer. It is also conceivable that a hydrophobic surface structure is introduced into or applied to the wall of the protective element 115 in the narrow region 125, as shown in greater detail for reasons of clarity in the exemplary embodiment shown in FIG. 2.

FIG. 2 shows a sectional view through a second exemplary embodiment of the pressure-sensor element 100. In contrast to the exemplary embodiment shown in FIG. 1, the narrow region 125 now comprises a step 200, in which the narrow region 125 tapers further towards the pressure sensor 105. Such a design of the step 200 can also further increase the protective function, since, for example, larger objects are held in the upper, wider region of the narrow region 125 and thus cannot reach the sensor region of the pressure sensor 105. Liquids, for example, can still be deposited on the step 200 if they do penetrate into the narrow region 125, so that this liquid can be prevented from passing directly onto the pressure sensor 105. At the same time, it can be seen that the retaining projection 135 or the retaining projections 135 are designed to be planar or flush with an opening or the passage of the narrow region 125 into the wide region 120. In this way, the individual components of the protective element 115 can also be manufactured in a technically very simple manner. FIG. 2 also shows a hydrophilic surface structure 210 on an edge region of the inner wall of the wide region 120, which can serve to bind or store any liquid deposited in the wide region 120 on this hydrophilic surface structure 210. Alternatively or additionally, a hydrophobic surface structure 220 may also be disposed on an inner wall of the narrow region 125 to prevent deeper penetration of liquid into the narrow region 125 by providing such a structure. The hydrophilic surface structure 210 and the hydrophobic surface structure 220 can be realized, for example, by a coating and/or by an etching of a structure into the wall of the respective part of the protective element 115.

FIG. 3 shows a sectional view through a third exemplary embodiment of the pressure-sensor element 110 proposed here. In contrast to the exemplary embodiments shown in FIGS. 1 and 2, the base region 130 of the wide region 120 is now designed at an angle, so that this base region 130 is at a greater distance from the pressure sensor 105 at an opening or the passage 132 of the narrow region 125 into the wide region 120 than in the edge region 140 at a side wall of the protective element 115 of the wide region 120. On the one hand, the protective function can also be realized by the retaining projection 135 by means of such an inclined base region 130. At the same time, such an embodiment of the protective element 115 is technically very easy to manufacture, since, for example, the demoldability of such a protective element 115 is improved by avoiding small portions of this protective element 115.

FIG. 4 shows a sectional view through a fourth exemplary embodiment of the pressure-sensor element 100 presented here. In contrast to the exemplary embodiment shown in FIG. 3, the exemplary embodiment of the pressure-sensor element 100 shown in FIG. 4 also comprises a step 200 in the narrow region 125, as already described and shown in the exemplary embodiment shown in FIG. 2. The function of this step 200 substantially corresponds to the function of the step 200 as described in greater detail in the exemplary embodiment shown in FIG. 2. Furthermore, it can be seen that the inner walls 400 of the narrow region 125 are substantially parallel in order to enable the pressure sensor 105 to measure the pressure as accurately as possible. In order to enable the most efficient possible separation of any liquid contained in the gas 110, the inner wall 410 or inner walls in the wide region 120 can also be designed conically or to form a tapering channel 117 in order to guide liquid separated on this wall or these walls into the base portion 130 and collect it there.

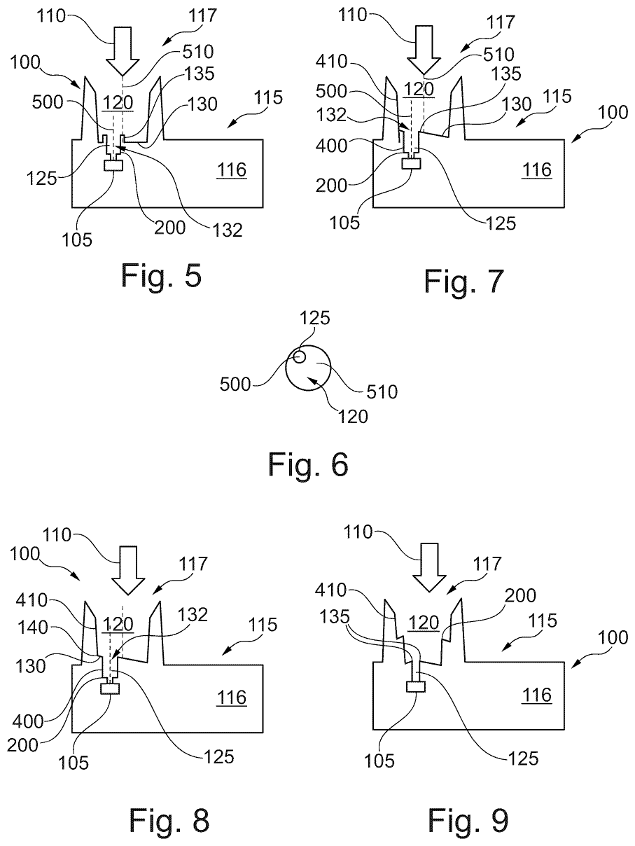

FIG. 5 shows a sectional view of a fifth exemplary embodiment of the pressure-sensor element 100 presented here. It can be seen here that the narrow region 125 is asymmetrical in relation to the wide region 120, i.e., a (symmetry) axis 500 through the narrow region 125 is, for example, displaced or offset in relation to a (symmetry) axis 510 through the wide region 120.

FIG. 6 shows a schematic top view of the wide region 120 and the narrow region 125, wherein the displacement or offset of the axis 510 of the narrow region 125 in relation to the axis 510 of the wide region 120 is recognizable. Particularly where the narrow region 125 is very narrow or even flush with the wide region 120, such an arrangement can be very helpful in preventing impurities from penetrating into the narrow region 125.

FIG. 7 shows a sectional view through a sixth exemplary embodiment of the pressure-sensor element 100 presented here. Here, the base region 130 is again arranged obliquely, although now the base region 130 in the part where the inner wall 400 of the narrow region 125 is closer to the inner wall 410 of the wide region 120 also slopes obliquely in the direction of the passage 132. In this way, for example, a virtually flush transition can be achieved between the wide region 120 and the narrow region 125.

FIG. 8 shows a sectional view through a seventh exemplary embodiment of the pressure-sensor element 100 presented here. In contrast to the exemplary embodiment of the pressure-sensor element 100 shown in FIG. 7, that part of the base region 130 in which the inner wall 400 of the narrow region 124 is closer to the inner wall 410 of the wide region 120 is no longer inclined in the direction of the passage 132, but rises from an edge region 140 to the retaining projection 135. As a result, for example, a liquid flowing off the inner wall 410 of the wide region 120 can be collected in the edge region 140. In such an embodiment, which is designed in a Vilkan shape but with different slopes, optimized moisture management and/or moisture collection can be achieved due to the asymmetrical hole position, i.e., the asymmetrical position of the narrow region 120 in relation to the wide region 120.

FIG. 9 shows a sectional view through an eighth exemplary embodiment of the pressure-sensor element 100 presented here. In contrast to the exemplary embodiment of the pressure-sensor element 100 shown in FIG. 3, a step 200 is now also provided in an inner wall 410 of the wide region 120. In addition, an offset arrangement of the narrow region 125 in relation to the wide region 120 is also provided again.

In summary, it should therefore be noted that the approach presented here discloses and describes in more detail a pressure sensor with a protective function. The basic idea of the invention with the resulting advantages can be seen in the fact that a pressure sensor with a protective function close to the sensitive region (locally in the so-called pressure chimney or protective element) comprises a protection of its function against moisture/liquids. The term “protection” is to be understood here as reducing the probability of the negative consequences described above occurring or preventing these consequences from occurring altogether. Likewise, consequences for the function resulting from icing can be avoided as efficiently as possible. The protection can be geometrically designed in such a way that the penetration of liquid, which collects for example inside the chimney or protective element, into the sensitive region (or the constriction) is made more difficult. This can be achieved by completely or partially enclosing the constriction with the protection or retaining projection (closed circle or only partial shape), which may close off the inner edge of the chimney or narrow region. This greatly reduces the area where moisture can enter. Additionally or alternatively, the protection or retaining projection can be extended by making the surface of the protection (the retaining projection) and optionally the inner surfaces of the constriction hydrophobic. This can be achieved, for example, by material selection and/or micro-structuring of the surface. A combination of hydrophobic regions (closer to the sensitive region) and hydrophilic regions (further away from the sensitive region, for example in the corners of the pressure chimney) is also possible. The advantages of such an embodiment can be listed as follows: Increased security of the system; Increased availability of the system; Greater freedom from temporary disturbances; Avoidance of long-term damage to the sensor; Keeping away not only water but also other liquids or substances contained in water; Reduced quality problems and field returns.

### LIST OF REFERENCE SIGNS

100 pressure-sensor element
105 pressure sensor
110 gas, air
115 protective element
116 chamber portion
117 channel
120 wide region
125 narrow region
130 base region, base portion
132 passage
135 retaining projection, protective wall
140 edge region, edge portion
150 hydrophilic surface structure
200 step
210 hydrophilic surface structure
220 hydrophobic surface structure
400 inner wall of the narrow region
410 inner wall of the wide region
500 (symmetry) axis through the narrow region
510 (symmetry) axis through the wide region

1.-12. (canceled)

13. A pressure-sensor element comprising:
a pressure sensor for sensing a pressure in a gas; and
a protective element which forms a channel with a wide region and a narrow region and comprises a retaining projection,
wherein the narrow region adjoins the pressure sensor,
wherein the narrow region has a smaller cross-section than the wide region,
wherein the protective element is arranged on the pressure sensor to allow gas to pass through both the wide region and the narrow region to the pressure sensor, and
wherein the retaining projection, which is arranged at a passage between the wide region and the narrow region, protrudes into the wide region from an edge portion of the wide region, to prevent liquid from entering the narrow region.

14. The pressure-sensor element according to claim 13, wherein one end of the retaining projection has a greater distance to the pressure sensor than a base region of the wide region.

15. The pressure-sensor element according to claim 14, wherein the base region has at least one of a falling and inclined course from the retaining projection, and the base region adjacent to the retaining projection has a greater distance to the pressure sensor than an edge of the base region opposite the retaining projection.

16. The pressure-sensor element according to claim 14, wherein the base region has a substantially parallel orientation with respect to the orientation of the pressure sensor.

17. The pressure-sensor element according to claim 14, wherein the retaining projection is shaped as at least one of an elevation and a ridge.

18. The pressure-sensor element according to claim 13, wherein the retaining projection is arranged circumferentially around the passage into the narrow region.

19. The pressure-sensor element according to claim 13, wherein the inner walls of the wide region are arranged at least one of conically and forming a tapering channel.

20. The pressure-sensor element according to claim 13, wherein the inner walls of the narrow region are arranged substantially parallel to each other.

21. The pressure-sensor element according to claim 13, wherein a wall of the narrow region is flush with the retaining projection.

22. The pressure-sensor element according to claim 13, wherein at least one of an inner wall of the narrow region and an inner wall of the wide region has a step.

23. The pressure-sensor element according to claim 22, wherein the step has a gradient falling from the passage to the edge region of the inner wall of at least one of the wide region and the narrow region.

24. The pressure-sensor element according to claim 13, wherein the protective element is at least partially cylindrical in shape.

25. The pressure-sensor element according to claim 13, wherein the protective element is partially comprised of at least one of a plastics material and a rubber material.

26. The pressure-sensor element according to claim 13, wherein the pressure sensor is embedded in a chamber portion of the protective element.

27. The pressure-sensor element according to claim 13, wherein the narrow region is arranged asymmetrically with respect to the wide region.

28. The pressure-sensor element according to claim 13, the inner side of a wall of the wide region comprises a hydrophilic surface structure.

29. The pressure-sensor element according to claim 28, wherein the hydrophilic surface structure is located at an end facing the narrow region.

30. The pressure-sensor element according to claim 13, wherein a hydrophobic surface structure is provided on an inner side of a wall of the narrow region.

31. The pressure-sensor element according to claim 13, wherein the protective element is at least one of fully comprised and partially comprised of a hydrophobic material.

32. The pressure-sensor element according to claim 31, wherein a hydrophobic surface structure is provided on an inner side of a wall of the narrow region.
